(19) United States
(12) Patent Application Publication
(10) Pub. No.: US 2015/0300434 A1
(43) Pub. Date: Oct. 22, 2015

(54) AIRFLOW DEFLECTOR FOR BRAKE COOLING

(71) Applicant: GM GLOBAL TECHNOLOGY OPERATIONS LLC, Detroit, MI (US)

(72) Inventors: Omar Morales Perez, Mexico City (MX); Manuel Agustin Lopez Zamacona, Calimaya (MX)

(73) Assignee: GM GLOBAL TECHNOLOGY OPERATIONS LLC, Detroit, MI (US)

(21) Appl. No.: 14/256,474

(22) Filed: Apr. 18, 2014

(51) Int. Cl. F16D 65/847; B62D 35/02

(52) U.S. Cl. CPC F16D 65/847; B62D 35/02

(57) ABSTRACT

A fascia for a vehicle having a body front end, a distal body rear end, and a brake subassembly for decelerating the vehicle is disclosed. The fascia is configured to divert an incident airflow around the body front end and includes a fastening provision for attachment to the body front end. The fascia also includes a deflector having an airfoil shape and configured to direct the incident airflow to the brake subassembly for cooling thereof. A vehicle employing such a fascia is also disclosed.

### TECHNICAL FIELD

The present disclosure relates to an airflow deflector for brake cooling in a vehicle.

### BACKGROUND

A brake is typically a mechanical device designed to inhibit motion. Brakes commonly use friction to convert kinetic energy into heat, though other methods of energy conversion may be employed. For example regenerative braking converts much of the kinetic energy to electric energy, which may be stored for later use.

On vehicles, braking systems are employed to apply a retarding force, typically via frictional elements at the vehicle's rotating axles or wheels, to inhibit vehicle motion. Friction brakes often include stationary shoes or pads that are lined with friction material and configured to be engaged with a rotating wear surface, such as a rotor or a drum. Common configurations include shoes that contact to rub on the outside of a rotating drum, commonly called a “band brake”, a rotating drum with shoes that expand to rub the inside of a drum, commonly called a “drum brake”, and pads that pinch a rotating disc, commonly called a “disc brake”.

Modern vehicles typically use a hydraulic force to press the aforementioned shoes or pads against the respective rotating disc or drum, which slows the disc or drum and its attendant wheel. Generally, vehicle friction brakes store thermal energy in the disc brake or drum brake while the brakes are being applied and then gradually transfer the stored heat to the ambient. Accordingly, during extended brake applications such as occur when vehicle motion is retarded from elevated speeds, the drums or rotors, as well as respective shoes or pads, may experience extensive accumulation of heat.

### SUMMARY

A fascia for a vehicle having a body front end, a distal body rear end, and a brake subassembly for decelerating the vehicle is disclosed. The fascia is configured to divert an incident or oncoming airflow around the body front end and includes a fastening provision for attachment to the body front end. The fascia also includes a deflector having a wing or airfoil shape and configured to direct the incident airflow to the brake subassembly for cooling thereof.

The brake subassembly may include a brake rotor. Furthermore, the deflector may direct the incident airflow to the rotor.

The deflector may include an outer surface arranged to come into contact with the incident airflow. Additionally, the deflector may include a rib projection arranged on the outer surface and configured to direct the incident airflow toward the brake subassembly.

The deflector may include a plurality of depressions arranged on the outer surface and configured to streamline the incident airflow, i.e., facilitate laminar flow of the resultant airstream. When the outer surface is viewed from the top, each of the plurality of depressions may have an elliptical shape.

The deflector may be constructed from a plastic material.

The vehicle may include a plurality of brake subassemblies and a corresponding plurality of deflectors.

The deflector may include closed sides configured to enhance rigidity or stiffness of the deflector.

The deflector may define a mounting provision for attachment of the deflector to the fascia.

The deflector may be mounted to the fascia via at least one fastener.

A vehicle having the above fascia and employing road wheels and corresponding brake subassemblies that are configured to retard rotation of the wheels for decelerating the vehicle is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic plan view of a motor vehicle having a braking system and a deflector arranged on the vehicle's front fascia according to the disclosure.

FIG. 2 is a schematic cross-sectional view of a brake subassembly that is part of the braking system shown in FIG. 1, wherein the brake subassembly is configured as a disc brake and includes a brake pad with a friction segment.

FIG. 3 is a schematic side view of a brake subassembly that is part of the braking system shown in FIG. 2, wherein the brake subassembly is configured as a drum brake and includes a brake shoe with a friction segment.

FIG. 4 is a schematic close-up perspective view of one deflector arranged on the front fascia shown in FIG. 1.

FIG. 5 is a schematic perspective view of the deflector shown in FIGS. 1 and 4.

FIG. 6 is a schematic cross-sectional view of the deflector's outer surface having a modified “Raf33” airfoil shape.

FIG. 7 is a schematic illustration of a top view of depressions arranged on the deflector's outer surface.

FIG. 8 is a schematic illustration of a cross-sectional side view of depressions arranged on the deflector's outer surface.

### DETAILED DESCRIPTION

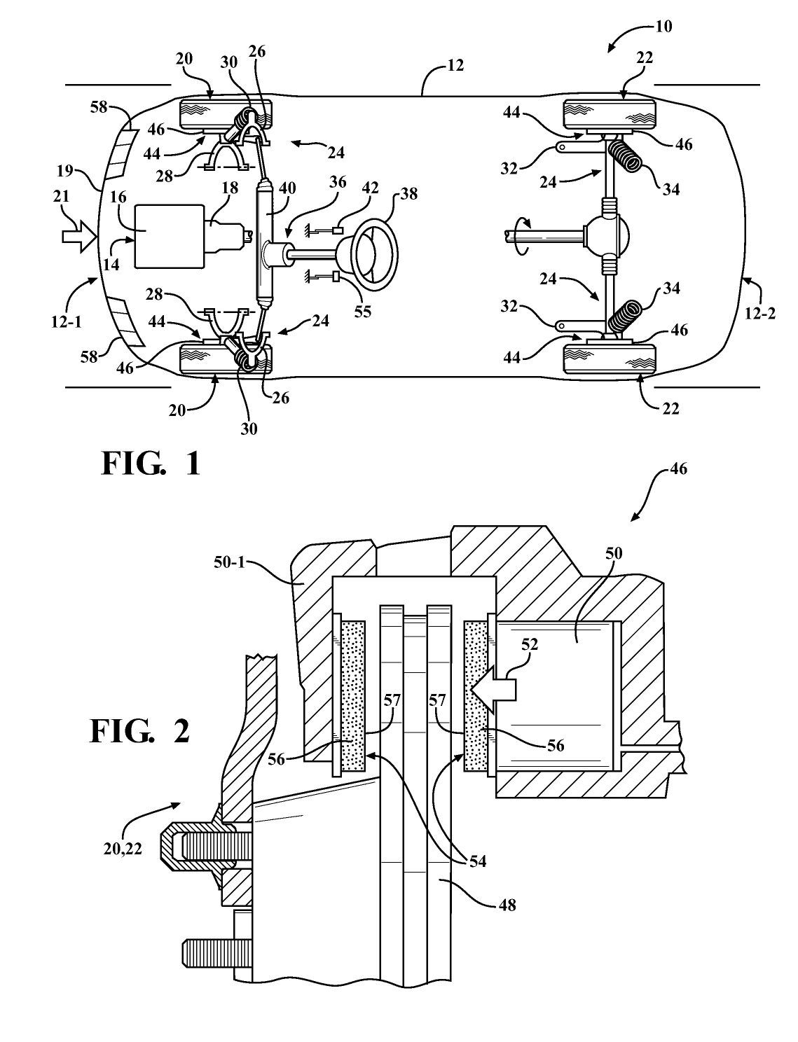

Referring to the drawings, wherein like reference numbers refer to like components, FIG. 1 shows a schematic view of a motor vehicle 10, which includes a vehicle body 12. The vehicle 10 also includes a powertrain 14 configured to propel the vehicle. As shown in FIG. 1, the powertrain 14 includes an engine 16 and a transmission 18. The powertrain 14 may also include one or more motor/generators as well as a fuel cell, neither of which are shown, but a powertrain configuration employing such devices is appreciated by those skilled in the art.

The vehicle body 12 includes a front end 12-1 and a distal rear end 12-2. The vehicle 10 also includes a front fascia 19 arranged at the front end 12-1 and configured to divert an incident or oncoming airflow 21 around the front end, as well as into the vehicle for such purposes as cooling of the engine 16 and supplying air to a Heating, Ventilation, and Air Conditioning (HVAC) system (not shown).

The vehicle 10 also includes a plurality of rotatable road wheels, such as front wheels 20 and rear wheels 22. Although four wheels, i.e., a pair of front wheels 20 and a pair of rear wheels 22, are shown in FIG. 1, a vehicle with fewer or greater number of road wheels is also envisioned. As shown, a vehicle suspension system 24 operatively connects the body 12 to the respective front and rear wheels 20, 22 for maintaining contact between the wheels and a road surface, and for maintaining handling of the vehicle. The suspension system 24 may include an upper control arm 26, a lower control arm 28 and a strut 30 connected to each of the front wheels 20. The suspension system 24 may also include a trailing arm 32 and a spring 34 connected to each of the rear wheels 22. Although a specific configuration of the suspension system 24 is shown in FIG. 1, other vehicle suspension designs are similarly envisioned.

As shown in FIG. 1, a vehicle steering system 36 is operatively connected to the front wheels 20 for steering the vehicle 10. The steering system 36 includes a steering wheel 38 that is operatively connected to the front wheels 20 via a steering rack 40. The steering wheel 38 is arranged inside the passenger compartment of the vehicle 10, such that an operator of the vehicle may command the vehicle to assume a particular direction with respect to the road surface. Additionally, an accelerator pedal 42 is positioned inside the passenger compartment of the vehicle 10, wherein the accelerator pedal is operatively connected to the powertrain 14 for commanding propulsion of the vehicle 10.

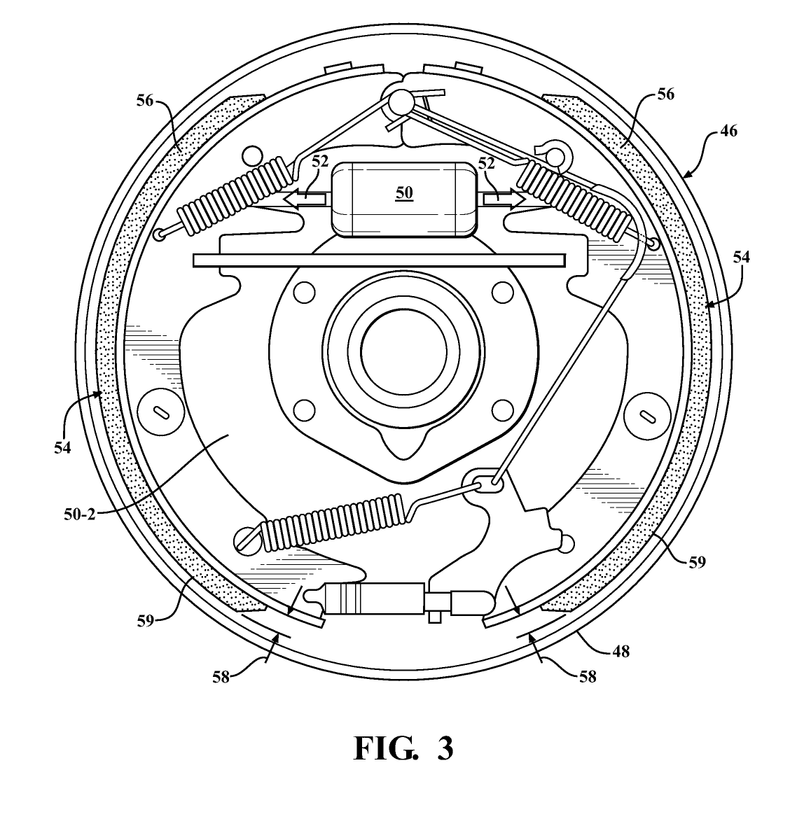

As shown in FIG. 1, a vehicle braking system 44 is operatively connected to the respective front and rear wheels 20, 22 for retarding rotation of the wheels and decelerating the vehicle 10. The braking system 44 includes a friction braking subassembly 46 arranged at each of the respective front and rear wheels 20, 22. Each braking subassembly 46 may be configured as either a disc brake (shown in FIG. 2) or a drum brake (shown in FIG. 3). Each braking subassembly 46 includes a rotor 48 configured for synchronous rotation with the respective wheel 20, 22. Rotor material is generally selected for advantageous friction and wear characteristics, as well as effective heat resistance. Typically, rotors are formed out of cast iron, but may in some cases be made of composites such as reinforced carbon-carbon or ceramic matrix composites. Each braking subassembly 46 additionally includes an actuator 50, such as a hydraulically activated piston arranged in a brake caliper 50-1 of a disc brake (shown in FIG. 2) or in a foundation 50-2 of a drum brake (shown in FIG. 3), and configured to generate an actuator force 52.

As shown in FIGS. 2 and 3, each braking subassembly 46 also includes a brake component 54 having a wearable friction lining or segment 56. The friction segment 56 additionally includes a friction surface 57 that becomes pressed into contact with the rotor 48 by the actuator force 52 for retarding rotation of the respective wheel 20, 22. Typically, friction segments are composed of relatively soft but tough and heat-resistant materials having a high coefficient of dynamic friction, and, ideally an identical coefficient of static friction. The friction segment 56 is the portion of the braking subassembly 46 which converts the vehicle's kinetic energy into thermal energy that is intially largely absorbed by the rotor 48 and subsequently given off via radiation and/or convection to the ambient. Such absorption of thermal energy may cause excessive wear on the friction segment 56 and the rotor 48, thermally induced dimensional distortion of the rotor, and brake fade, i.e., a decrease in the brake's stopping power.

The complete brake component 54 (including the friction segment 56) is typically called a “brake pad” or “brake shoe”. As shown in FIG. 2, if the braking subassembly 46 is configured as a disc brake, the rotor 48 is configured as a disc rotor and the brake component 54 is correspondingly configured as a disc brake pad. As shown in FIG. 3, if the braking subassembly 46 is configured as a drum brake, the rotor 48 is configured as a brake drum and the brake component 54 is correspondingly configured as a drum brake shoe.

As shown in FIG. 2, in a disc brake, the caliper 50-1 is generally configured to hold a pair of braking components 54, i.e., brake pads, relative to the rotor 48, i.e., disc rotor, and apply the actuator force 52 to the brake pads in order to squeeze the disc rotor for decelerating the vehicle 10. As shown in FIG. 3, in a drum brake, a pair of brake components 54, i.e., brake shoes, are generally held inside the rotor 48, i.e., drum, and the actuator 50 applies the actuator force 52 to press the brake shoes against a perimeter of the inner surface of the drum to decelerate the vehicle 10. Additionally, in each case, of disc and drum brakes of FIGS. 2 and 3, respectively, the actuator force 52 is controlled via a brake pedal 55 (shown in FIG. 1). The brake pedal 55 is positioned inside the passenger compartment of the vehicle 10, and is adapted to be controlled by the operator of the vehicle.

As shown in FIGS. 1 and 4, deflectors 58 having a wing or airfoil shape are arranged on the front fascia 19. As shown in FIG. 1, at the front end 12-1, the vehicle 10 includes one brake subassembly 46 for each front wheel 20 and a corresponding plurality of deflectors 58. Each deflector 58 is configured to direct the incident airflow 21 to the respective brake subassembly 46 for cooling thereof by forced convection. In other words, the deflector 58 is shaped as an airfoil to take advantage of the subject shape's aerodynamic signature in order to efficiently divert and direct the airflow 21 to flow over the rotor 48, the brake caliper 50-1, and the brake component 54 for removing heat therefrom.

Because location of the deflectors 58 on the vehicle body 12 is dictated by packaging of the braking subassemblies 46 in the vehicle 10, it is conceivable that positioning of the deflectors 58 on the front fascia 19 could be in a general area of the vehicle body 12 that experiences reduced pressure from the incident airflow 21 when the vehicle is in motion. As understood by those skilled in the art, the actual distribution of air pressure across the front fascia 19 is dependent on the aerodynamic signature of the vehicle body 12, wherein less aerodynamic vehicles may experience a greater number of low pressure zones that are likely to generate swirling vortices that are caused by unsteady separations of the incident airflow 21. The deflectors 58 may be constructed from an easily formed, tough material, such as injection molded plastic. As shown in FIG. 4, the deflectors 58 may be mounted to the front fascia 19 via one or more fasteners 60 or be incorporated into the front fascia structure for a resultant unitary or single-piece construction. For the purpose of attachment via fasteners 60, the deflector 58 may define mounting provisions or apertures 62 for attachment of the deflector to the fascia 19.

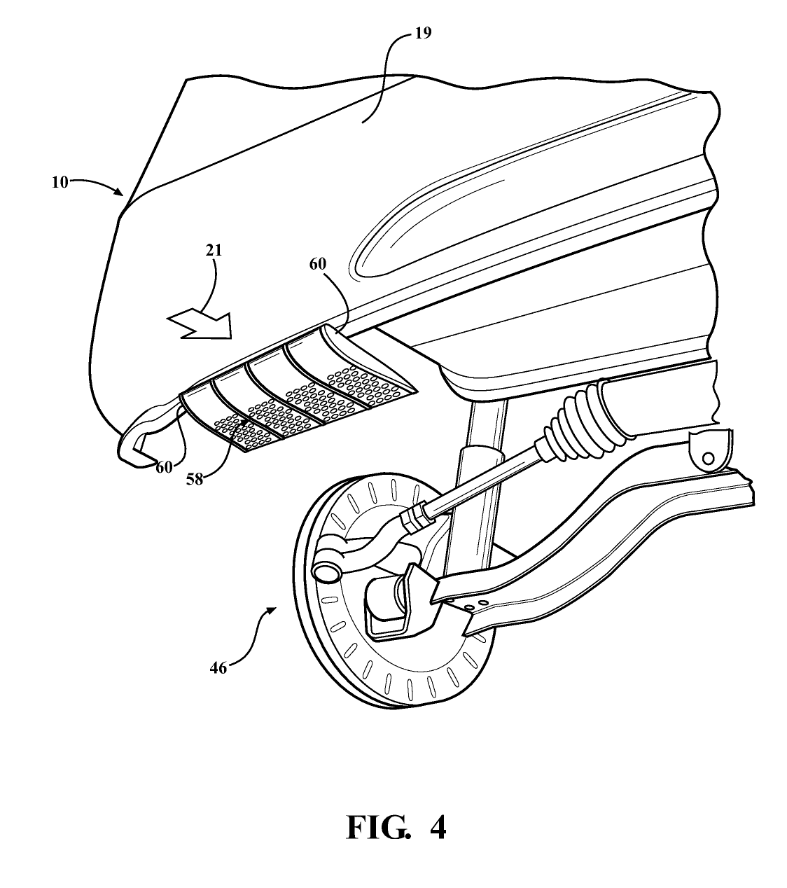

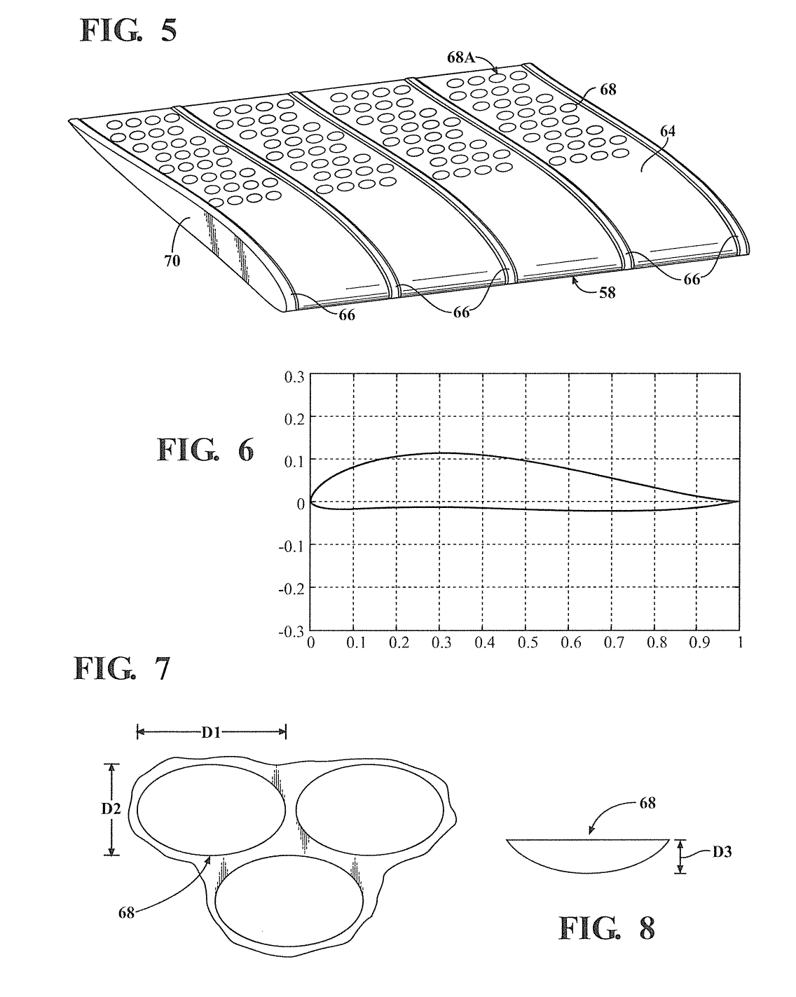

As shown in FIG. 5, the deflector 58 includes an outer surface 64 arranged to come into contact with the incident airflow 21 when the vehicle 10 is in motion. The deflector's outer surface 64 may have a modified version of an “Raf 33” airfoil shape (shown in FIG. 6) that has been used by the aerospace industry for aircraft wings. In the subject modified Raf 33 airfoil shape, the airfoil's top surface is retained for directing an airflow stream at lower air speeds, as primarily encountered by road vehicles, while the airfoil's bottom surface that would typically generate lift in an aircraft wing is removed. As may be seen in FIG. 5, a plurality of rib projections 66 may be arranged on the outer surface 64. The rib projections 66 may have a height of around 10 mm from the outer surface 64 and be configured to direct the incident airflow 21 toward the brake subassembly 46, as well as add rigidity to the structure of deflector 58. As additionally shown in FIG. 5, each deflector 58 may also include a plurality of dimples or depressions 68 arranged on the outer surface 64. As may be seen in FIG. 7, each depression 68 may have a substantially elliptical shape when observed in a true top view of the outer surface 64. Additionally, the elliptical shape of the depression 68 may have a large diameter D1 to a small diameter D2 ratio (D1:D2) in the range of 1.35-1.5. Additionally, as may be seen in FIG. 8, each depression 68 may have a depth D3 in the range of 1-1.5 mm and be spaced from the neighboring depressions by around 10-20 mm.

With resumed reference to FIG. 5, the depressions 68 of each deflector 58 may be grouped in a field 68A located in a general area on the outer surface 64 that experiences reduced pressure from the incident airflow 21 and a resultant vortex zone even when the vehicle 10 is moving at elevated road speeds, such as above 60 kilometers per hour. The depressions 68 grouped in the field 68A are configured, i.e., shaped and positioned to induce “Von Kármán vortex street” effect, where a repeating pattern of micro-vortices is generated by separation of incident airflow 21 at the depressions 68. The depressions 68 are intended to induce air micro-vortices on the outer surface 64 and prevent formation of swirling eddies in the incident airflow 21, thus smoothing out the incident airflow. Accordingly, via the depressions 68, turbulent incident airflow 21 is facilitated to become laminar and remain attached to the outer surface 64 when the vehicle 10 is in motion. Each field 68A may include around 30-40 individual depressions 68. Hence, the fields 68A are configured to streamline the incident airflow 21, i.e., facilitate laminar flow of the oncoming stream of air. As shown, each deflector 58 may additionally include closed sides 70 that are configured to enhance rigidity of the deflector such that the deflector shape does not deform or bend due to the force of the incident airflow 21.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A fascia for a vehicle having a body that includes a front end and a distal rear end, and a brake subassembly for decelerating the vehicle, the fascia configured to divert an incident airflow around the front end and comprising:
a fastening provision for attachment to the front end; and
a deflector having an airfoil shape and configured to direct the incident airflow to the brake subassembly for cooling thereof;
wherein the deflector includes:
an outer surface arranged to come into contact with the incident airflow; and
a plurality of depressions arranged on the outer surface and configured to streamline the incident airflow by inducing a Von Kármán vortex street effect such that a repeating pattern of micro-vortices is generated by separation of the incident airflow at the depressions.

2. The fascia according to claim 1, wherein the brake subassembly includes a brake rotor, and wherein the deflector directs the incident airflow to the brake rotor.

3. The fascia according to claim 1, wherein the deflector includes a rib projection arranged on the outer surface and configured to direct the incident airflow toward the brake subassembly.

4. (canceled)

5. The fascia according to claim 1, wherein each of the plurality of depressions has an elliptical shape defined by a large diameter to a small diameter ratio in a range of 1.35 to 1.5.

6. The fascia according to claim 1, wherein the deflector is constructed from a plastic material.

7. The fascia according to claim 1, wherein the vehicle includes a plurality of the brake subassemblies and a corresponding plurality of the deflectors.

8. The fascia according to claim 1, wherein the deflector includes closed sides configured to enhance rigidity of the deflector.

9. The fascia according to claim 1, wherein the deflector defines a mounting provision for attachment of the deflector to the fascia.

10. The fascia according to claim 9, wherein the deflector is mounted to the fascia via at least one fastener.

11. A vehicle comprising:
a vehicle body having a front end and a distal rear end;
a front fascia arranged at the front end of the vehicle body and configured to divert an incident airflow around the front end;
a rotatable road wheel arranged proximate to the front fascia;
a brake subassembly configured to retard rotation of the road wheel; and
a deflector having an airfoil shape, arranged on the front fascia, and configured to direct the incident airflow to the brake subassembly for cooling thereof;
wherein the deflector includes:
an outer surface arranged to come into contact with the incident airflow; and
a plurality of depressions arranged on the outer surface and configured to streamline the incident airflow by inducing a Von Kármán vortex street effect such that a repeating pattern of micro-vortices is generated by separation of the incident airflow at the depressions.

12. The vehicle according to claim 11, wherein the brake subassembly includes a brake rotor, and wherein the deflector directs the incident airflow to the brake rotor.

13. The vehicle according to claim 11, wherein the deflector includes a rib projection arranged on the outer surface and configured to direct the incident airflow toward the brake subassembly.

14. (canceled)

15. The vehicle according to claim 11, wherein each of the plurality of depressions has an elliptical shape defined by a large diameter to a small diameter ratio in a range of 1.35 to 1.5.

16. The vehicle according to claim 11, wherein the deflector is constructed from a plastic material.

17. The vehicle according to claim 11, wherein the vehicle includes a plurality of the brake subassemblies and a corresponding plurality of the deflectors.

18. The vehicle according to claim 11, wherein the deflector includes closed sides configured to enhance rigidity of the deflector.

19. The vehicle according to claim 11, wherein the deflector defines a mounting provision for attachment of the deflector to the fascia.

20. The vehicle according to claim 19, wherein the deflector is mounted to the fascia via at least one fastener.
